(19) United States
(12) Patent Application Publication
(10) Pub. No.: US 2017/0173748 A1
(43) Pub. Date: Jun. 22, 2017

(54) Suction Device for a Portable Power Tool

(71) Applicant: Robert Bosch GmbH, Stuttgart (DE)

(72) Inventors: Andre Ullrich, Leinfelden-Echterdingen (DE); Andreas Schlegel, Leinfelden-Echterdingen (DE); Christian Lang, Stuttgart (DE)

(21) Appl. No.: 15/377,805

(22) Filed: Dec. 13, 2016

(30) Foreign Application Priority Data
Dec. 18, 2015 (DE) 102015225864.5

(51) Int. Cl. B23Q 11/00; F16F 15/02; B25F 5/00

(52) U.S. Cl. CPC B23Q 11/0071; B23Q 11/0046; B25F 5/006; F16F 15/02

(57) ABSTRACT

A suction device for a portable power tool includes at least one suction unit for extracting and/or storing particles, in particular workpiece particles arising during machining of a workpiece with the portable power tool. The suction device further includes at least one damping unit for a vibration-damped arrangement of the suction unit on the portable power tool.

This application claims priority under 35 U.S.C. §119 to patent application no. DE 10 2015 225 864.5, filed on Dec. 18, 2015 in Germany, the disclosure of which is incorporated herein by reference in its entirety.

### BACKGROUND

DE 10 2005 062 464 A1 has already disclosed a suction device for a portable power tool, wherein the suction device has at least one suction unit for extracting and/or storing particles, in particular workpiece particles arising during machining of a workpiece with the portable power tool.

### SUMMARY

The disclosure is based on a suction device for a portable power tool, in particular for a hammer drill and/or chipping hammer, with at least one suction unit for extracting and/or storing particles, in particular workpiece particles arising during machining of a workpiece with the portable power tool.

It is proposed that the suction device has at least one damping unit for a vibration-damped arrangement of the suction unit on the portable power tool. In this context, “extraction” is intended to be understood as meaning in particular at least partially transporting away and/or removing particles, in particular at least partially with the aid of a fluid flow (air flow), particularly preferably by means of negative pressure. The suction device can have a drive unit, in particular an electric motor (EC motor, DC motor or the like), for producing the fluid flow, or the fluid flow can be produced by means of a drive unit (EC motor, DC motor or the like) of the portable power tool when the suction device is arranged on the portable power tool. It is conceivable for the fluid flow to be able to be produced by means of a fan wheel for cooling the drive unit of the suction device or the drive unit of the portable power tool, or for an additional fluid flow element, in particular an additional fan wheel, to be able to be driven by the drive unit of the suction device or the drive unit of the portable power tool.

A “damping unit” is intended to be understood here as meaning in particular a unit which is preferably provided for reducing a transmission of vibrations, in particular of mechanical vibrations, by means of elastic deformation or by means of a relative movement, in particular by means of a relative movement different from a relative movement induced by component tolerances or induced by bearing tolerances. “Provided” is intended to be understood as meaning in particular specially designed and/or specially equipped. By the fact that an element and/or a unit are/is provided for a certain function is intended to be understood as meaning in particular that the element and/or the unit satisfy/satisfies and/or carry out/carries out said certain function in at least one use state and/or operating state.

The damping unit preferably has at least one damping element which is provided for arranging the suction unit on the portable power tool in such a manner that the suction unit is movable in a vibrating manner relative to the portable power tool. The damping unit is particularly preferably designed in particular differently from a sealing element which is provided for a dustproof connection of two suction elements of the suction unit or of a suction element and a suction channel opening of a housing of the portable power tool. The damping element can be designed in particular as a spring-elastic element, such as, for example, an elastomer, a helical spring, a disk spring, a volute spring, a spring-elastic compound and/or another spring-elastic element appearing suitable to a person skilled in the art. In this context, a “spring-elastic element” is intended to be understood as meaning in particular an element which, by reversible deformation, absorbs energy and at least partially releases same again, wherein the deformation is preferably greater than 2% of a longitudinal extent of the spring-elastic element. The damping element is elastically compressible in particular by more than 0.1 mm, preferably by more than 1 mm and particularly preferably by more than 3 mm. However, it is also conceivable for the damping element to be part of a movement mechanism which is provided for mounting the suction unit in a vibratingly movable manner relative to the portable power tool, in particular in a vibratingly movable manner on the housing of the portable power tool.

The damping unit for a vibration-damped arrangement of the suction unit is preferably provided for converting kinetic energy into heat energy, in particular in a manner decoupled from bearing-induced friction heat. The damping unit can have any configuration appearing expedient to a person skilled in the art for a vibration-damped arrangement of the suction unit, such as, for example, a configuration in the form of a rotation damping unit, an axial damping unit, a magneto-rheological damping unit, a magnetic damping unit or a further damping unit appearing expedient to a person skilled in the art. By means of the configuration according to the disclosure, vibration decoupling of the suction unit from vibrations which can be produced during operation of the portable power tool can advantageously be achieved. A component-protecting arrangement of the suction unit on the portable power tool can advantageously be made possible. A long service life of the suction unit can advantageously be achieved since, as a result of the damping unit, the suction unit is exposed to slight vibrations when the suction unit is arranged on the portable power tool. When the suction unit is arranged on the portable power tool, it is advantageously possible for a relative movement of the suction unit relative to the portable power tool to be achieved, said relative movement advantageously being usable for vibration damping of vibrations acting on an operator of the portable power tool.

Furthermore, it is proposed that the damping unit has at least one damping element which is in the form of an elastomer or a joint, wherein the damping element is at least partially arrangeable between the portable power tool and the suction unit. In a configuration of the damping element as a joint, the damping element is preferably part of a coupler mechanism. However, it is also conceivable for the damping element to have a different configuration appearing expedient to a person skilled in the art for a vibration-damped arrangement of the suction unit. By means of the configuration according to the disclosure, a vibration-damped arrangement of the suction unit on the portable power tool can be realized in a structurally simple manner.

Furthermore, it is proposed that the suction device comprises at least one fastening unit which has at least one fastening interface for fastening the suction unit to the portable power tool, wherein at least one damping element of the damping unit is arranged at the fastening interface. In particular, the fastening interface is provided for coupling to a corresponding interface of the portable power tool. The fastening unit, in particular the fastening interface, is preferably provided for a form-fitting and/or force-fitting connection to the portable power tool, in particular to the interface of the portable power tool. An electrical contact interface of the suction unit with an energy supply unit of the suction unit and/or with the drive unit of the suction device can be arranged at the fastening interface, in particular can be formed integrally with the fastening interface. “Integrally” is intended to be understood as meaning in particular connected at least in an integrally bonded manner, for example by means of a welding process, an adhesive bonding process, an injection molding process and/or another process appearing expedient to a person skilled in the art, and/or advantageously as meaning formed in one piece, for example by production from a casting and/or by production in a single- or multi-component injection molding process and advantageously from an individual blank. By means of the configuration according to the disclosure, a secure arrangement of the suction unit on the portable power tool can advantageously be achieved, said arrangement permitting an advantageous vibration damping of the suction unit.

In addition, it is proposed that the damping unit has at least one damping element which is designed to be adjustable with respect to at least one damping property. Preferably, at least one damping property in the form of a degree of damping is adjustable. It is conceivable for the damping unit to have at least one sensor element and at least one processor element which is provided for adjusting at least one damping property of the adjustable damping element at least partially automatically with reference to detected sensor characteristic variables. The at least one adjustable damping element is preferably designed as a magneto-rheological damping element. However, it is also conceivable for the adjustable damping element to have another configuration appearing expedient to a person skilled in the art, such as, for example, as a hydraulic damping element or the like. It is also conceivable for the damping unit to be formed independently of the at least one sensor element and the at least one processor element and for at least one damping property of the adjustable damping element to be adjustable manually by an operator. By means of the configuration according to the disclosure, an individual adaptation of at least one damping property of the adjustable damping element to at least one operating condition can advantageously be achieved.

Furthermore, it is proposed that the suction device comprises at least one energy supply interface for an arrangement of at least one exchangeable energy supply unit, in particular at least one battery pack, wherein at least one damping element of the damping unit is arranged at the energy supply interface of the suction device. In a manner already known to a person skilled in the art, the battery pack preferably comprises a multiplicity of individual battery cells which are electrically connected to one another. The energy supply interface of the suction device is preferably arranged on a side of the suction unit that faces away from a further side of the suction unit at which the fastening interface is arranged on the suction unit. The energy supply interface of the suction device is preferably provided for connecting the energy supply unit, in particular the battery pack, electrically to the suction unit. The energy supply interface of the suction device is advantageously provided for fastening the energy supply unit, in particular the battery pack, to the suction unit, in particular for fastening same removably to the suction unit. The energy supply interface of the suction device is preferably provided to be connected in a form-fitting manner and/or force-fitting manner to the energy supply unit, in particular to the battery pack. The damping element arranged on the energy supply interface of the suction device is preferably designed as a spring-elastic element. By means of the configuration according to the disclosure, an energy supply of the suction unit can advantageously be achieved, said energy supply being independent of an energy supply of the portable power tool, wherein the energy supply unit, in particular the battery pack, is arrangeable in a vibration-damped manner on the suction unit. In a configuration of the fastening interface in a manner corresponding to a battery interface of the portable power tool, the suction unit can advantageously be arranged at the battery interface of the portable power tool, wherein an energy supply of the portable power tool and of the suction unit can be obtained by means of a battery pack which is arrangeable at the energy supply interface, wherein the energy supply unit, in particular the battery pack, is arrangeable in a vibration-damped manner on the suction device.

Furthermore, it is provided that the damping unit has at least one energy-harvesting element which is provided for converting damping energy into electrical energy depending on a vibration damping of the damping unit. The at least one energy-harvesting element is preferably provided for converting heat, a movement, light irradiation, electromagnetic waves and/or other energy forms appearing expedient to a person skilled in the art into electrical energy. The energy-harvesting element is preferably designed as a piezo element for converting kinetic energy into electrical energy. Other configurations of the energy-harvesting element that appear expedient to a person skilled in the art are likewise conceivable. By means of the configuration according to the disclosure, a vibration-induced movement of the suction unit relative to the portable power tool can advantageously be converted into electrical energy.

In addition, the disclosure is based on a portable power tool with at least one housing, with at least one handle and with at least one suction device which is arrangeable removably on the housing and/or the handle, in particular with at least one suction device according to the disclosure. It is proposed that the portable power tool comprises at least one damping unit for a vibration-damped arrangement of the suction device on the housing and/or on the handle. A “portable power tool” is intended to be understood here as meaning in particular a power tool for machining workpieces, which power tool can be transported by an operator without using a transport machine. The portable power tool in particular has a mass which is smaller than 40 kg, preferably smaller than 10 kg and particularly preferably is smaller than 5 kg. The portable power tool is preferably in the form of a hammer drill and/or chipping hammer. However, it is also conceivable for the portable power tool to have another configuration appearing expedient to a person skilled in the art, such as, for example, a configuration in the form of a jack hammer, a hand drill, a grinding machine, a sawing machine or the like. By means of the configuration according to the disclosure, vibration decoupling of the suction unit from vibrations which can be produced during operation of the portable power tool can advantageously be achieved. A component-protecting arrangement of the suction unit on the portable power tool can advantageously be made possible. A long service life of the suction unit can advantageously be achieved since, as a result of the damping unit, the suction unit is exposed to slight vibrations when the suction unit is arranged on the portable power tool. When the suction unit is arranged on the portable power tool, a relative movement of the suction unit relative to the portable power tool can advantageously be achieved, said relative movement advantageously being usable for vibration damping of vibrations acting on an operator of the portable power tool.

Furthermore, it is proposed that the damping unit is at least partially arranged between the housing and the handle, wherein the suction device is arrangeable, at least for the greater part, on the handle. The damping unit preferably comprises at least one damping element which is arranged between the housing and the handle. The at least one damping element which is arranged between the housing and the handle is preferably provided for arranging at least the handle in a vibration-damped manner on the housing. As a result of arranging the suction device on the vibration-damped handle, the suction device is preferably arranged in a vibration-damped manner on the housing. In at least one configuration, the suction device additionally comprises a damping unit which is at least partially arrangeable between the suction device and the handle, in particular when the suction device is arranged on the handle. A vibration-damped arrangement of the suction device, preferably in a vibration-damped manner on the handle, can advantageously be achieved. By means of the configuration according to the disclosure, vibration decoupling of the suction device from vibrations which can be produced during operation of the portable power tool can advantageously be achieved. A component-protecting arrangement of the suction device on the portable power tool can advantageously be made possible. A long service life of the suction device can advantageously be achieved since, as a result of the damping unit, the suction device is exposed to slight vibrations when the suction device is arranged on the portable power tool. When the suction device is arranged on the portable power tool, a relative movement of the suction device relative to the portable power tool can advantageously be achieved, said relative movement advantageously being usable for vibration damping of vibrations acting on an operator of the portable power tool.

Furthermore, it is proposed that the portable power tool comprises at least one energy supply interface for an arrangement of at least one exchangeable energy supply unit, in particular at least one battery pack, on which the damping unit of the portable power tool is at least partially arranged, wherein the suction device is arrangeable releasably at the energy supply interface of the portable power tool. In particular, at least one damping element of the damping unit of the portable power tool is arranged at the energy supply interface of the portable power tool. The energy supply interface of the portable power tool is preferably at least partially arranged on the handle, in particular on a side of the handle that faces away from a motor housing of the housing of the portable power tool. By means of the configuration according to the disclosure, a structurally simple and vibration-damped arrangement of the suction device on the portable power tool can advantageously be achieved.

In addition, it is proposed that the housing has at least one receiving interface for receiving the suction device, wherein at least one damping element of the damping unit is arranged at the receiving interface. Additionally or alternatively to an arrangement at the energy supply interface of the portable power tool, the suction device can be arranged at the receiving interface of the housing. By means of the configuration according to the disclosure, a secure and in particular vibration-damped arrangement of the suction device on the portable power tool can advantageously be achieved.

The suction device according to the disclosure and/or the portable power tool according to the disclosure should not be limited here to the above-described application and embodiment. In particular, the suction device according to the disclosure and/or the portable power tool according to the disclosure can have a number of individual elements, components and units which differs from a number mentioned herein, in order to fulfill a functionality described herein. In addition, the ranges of values specified in this disclosure and also values lying within said limits should be considered to be disclosed and able to be used in any desired manner.

### BRIEF DESCRIPTION OF THE DRAWINGS

Further advantages can be gathered from the description below of the drawings. The drawings illustrate three exemplary embodiments of the disclosure. The drawings, the description, and the claims contain numerous features in combination. A person skilled in the art will expediently also consider the features individually and put them together to form meaningful further combinations.

In the drawings:

FIG. 1 shows a portable power tool according to the disclosure with a suction device according to the disclosure in a schematic illustration,

FIG. 2 shows an alternative portable power tool according to the disclosure with an alternative suction device according to the disclosure in a schematic illustration, and

FIG. 3 shows a further alternative portable power tool according to the disclosure with a further alternative suction device according to the disclosure in a schematic illustration.

### DETAILED DESCRIPTION

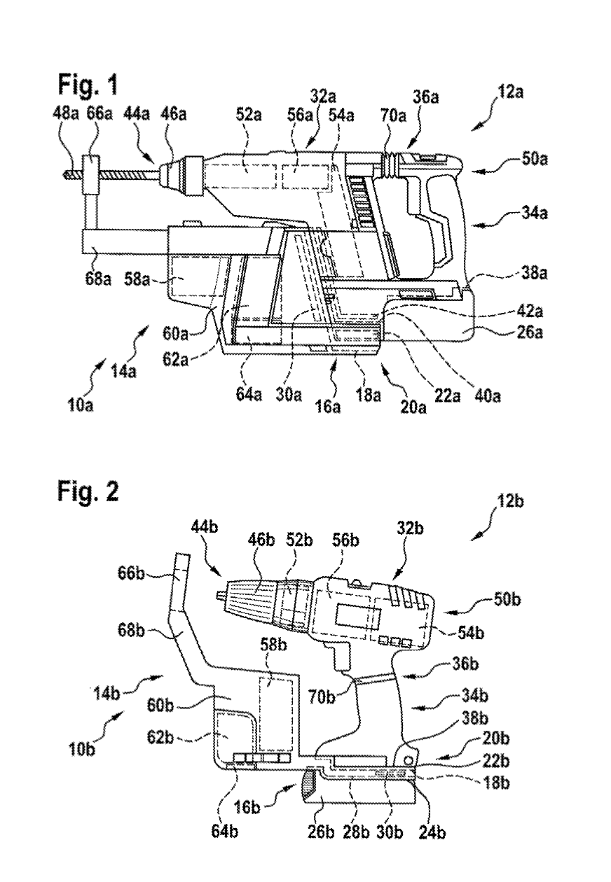

FIG. 1 shows a portable power tool 12a with at least one housing 32a, with at least one handle 34a and with at least one suction device 10a which is arrangeable removably on the housing 32a and/or on the handle 34a. In the exemplary embodiment illustrated in FIG. 1, the portable power tool 12a is in the form of a hammer drill and/or chipping hammer. However, it is also conceivable for the portable power tool 12a to have another configuration appearing expedient to a person skilled in the art, such as, for example, a configuration as a drilling machine, as a grinding machine, as a garden implement, as a jack hammer or the like. The portable power tool 12a comprises at least one striking mechanism device 52a. The portable power tool 12a comprises the housing 32a on which a tool-holding fixture 46a of the portable power tool 12a for receiving a machining tool 48a is arranged in a front region 44a. The tool-holding fixture 46a can be in the form of a clamping drill chuck, an SDS® tool-holding fixture or in the form of another tool-holding fixture appearing expedient to a person skilled in the art.

The handle 34a for guiding the portable power tool 12a and for transmitting a force from an operator to the portable power tool 12a on the housing 32a is arranged on a side 50a of the housing 32a that faces away from the front region 44a. The portable power tool 12a can additionally be formed with a releasable additional handle (not illustrated specifically here). The additional handle can be fastened releasably to the housing 32a of the portable power tool 12a, in particular in the region of the tool-holding fixture 46a, via a latching connection or other connections appearing expedient to a person skilled in the art. The portable power tool 12a comprises at least one energy supply interface 38a for an arrangement of at least one exchangeable energy supply unit 26a, in particular at least one battery pack. The energy supply interface 38a is arranged at an end of the handle 34a that faces away from the housing 32a.

In order to produce a driving torque and to produce a striking impulse by means of the striking mechanism device 52a, the portable power tool 12a has a drive unit 54a. The drive unit 54a is in the form of an electric motor. However, it is also conceivable for the drive unit 54a to have another configuration appearing expedient to a person skilled in the art, such as, for example, a configuration as an internal combustion engine, as a hybrid engine or the like. A driving torque of the drive unit 54a at least for producing a striking impulse can be transmitted to the striking mechanism device 52a via an output unit 56a of the portable power tool 12a. However, it is also conceivable for the portable power tool 12a to be designed in a manner decoupled from the output unit 56a and for the drive unit 54a for producing a striking impulse to act substantially directly on the striking mechanism device 52a. A striking impulse of the striking mechanism device 52a can be produced in a manner already known to a person skilled in the art. The driving torque for producing a rotational movement of the machining tool 48a can be transmitted to the tool-holding fixture 46a in a manner already known to a person skilled in the art via the output unit 56a and via a guide element of the striking mechanism device 52a, which guide element is in the form of a hammer tube (not specifically illustrated here), and/or via a rotational carry-along element (not illustrated specifically here) of the striking mechanism device 52a, said rotational carry-along element being arranged on the tool-holding fixture 46a.

The portable power tool 12a comprises at least one damping unit 36a for a vibration-damped arrangement of the suction device 10a on the housing 32a and/or on the handle 34a. The damping unit 36a of the portable power tool 12a is preferably provided for achieving a transmission of vibrations, in particular of mechanical vibrations, by means of an elastic deformation of at least one element of the damping unit 36a of the portable power tool 12a or by means of a movable mounting of the suction device 10a on the portable power tool 12a. The damping unit 36a of the portable power tool 12a preferably has at least one damping element 42a which is provided for arranging the suction device 10a on the portable power tool 12a in such a manner that the suction device 10a is movable in a vibrating manner relative to the portable power tool 12a. The damping element 42a of the damping unit 36a of the portable power tool 12a can be in particular in the form of a spring-elastic element, such as, for example, an elastomer, a helical spring, a disk spring, a volute spring, a spring-elastic compound and/or another spring-elastic element appearing suitable to a person skilled in the art. However, it is also conceivable for the damping element 42a of the damping unit 36a of the portable power tool 12a to be part of a movement mechanism which is provided for mounting the suction device 10a in a vibratingly movable manner relative to the portable power tool 12a, in particular for mounting same in a vibratingly movable manner on the housing 32a and/or on the handle 34a of the portable power tool 12a. The housing 32a has at least one receiving interface 40a for receiving the suction device 10a, wherein at least the damping element 42a of the damping unit 36a of the portable power tool 12a is arranged on the receiving interface 40a. The damping unit 36a of the portable power tool 12a comprises at least one further damping element 70a which is at least partially arranged between the housing 32a and the handle 34a. The damping unit 36a of the portable power tool 12a is preferably provided for a vibration-damped arrangement of the handle 34a on the housing 32a, in particular in addition to a vibration-damped arrangement of the suction device 10a on the housing 32a and/or on the handle 34a. As the result of arranging the energy supply unit 26a on the handle 34a, the energy supply unit 26a is arrangeable in a vibration-damped manner on the housing 32a of the portable power tool 12a by means of the further damping element 70a of the damping unit 36a of the portable power tool 12a when the energy supply unit 26a is arranged on the portable power tool 12a.

The suction device 10a is designed as a suction module. For the production of the fluid flow, the suction device 10a can have a drive unit 58a, in particular an electric motor (EC motor, DC motor or the like), or the fluid flow can be produced by means of the drive unit 54a of the portable power tool 12a when the suction device 10a is arranged on the portable power tool 12a. It is conceivable for the fluid flow to be able to be produced in a manner already known to a person skilled in the art by means of a fan wheel for cooling the drive unit 58a of the suction device 10a or of the drive unit 54a of the portable power tool 12a, or for an additional fluid flow element, in particular an additional fan wheel, to be drivable in a manner already known to a person skilled in the art by the drive unit 54a of the suction device 10a or of the drive unit 54a of the portable power tool 12a.

The suction device 10a for the portable power tool 12a comprises at least one suction unit 14a for extracting and/or storing particles, in particular workpiece particles arising during machining of a workpiece (not illustrated specifically here) with the portable power tool 12a. The suction unit 14a preferably comprises a collecting container 62a which is removable or detachable from a basic body 60a of the suction unit 14a. The suction unit 14a has at least one filter element 64a. The filter element 64a can be arranged on the collecting container 62a, or the filter element 64a can be arranged on the basic body 60a of the suction unit 14a at another position appearing expedient to a person skilled in the art, such as, for example, at a closure element of the suction unit 14a, in particular a cover or the like. The suction unit 14a comprises at least one suction element 66a which is arrangeable in the region of a workpiece machining side of the machining tool 48a. The suction element 66a is connectable to the collecting container 62a in particular in a manner already known to a person skilled in the art by means of a fluid flow channel 68a of the suction unit 14a. The suction element 66a is provided for surrounding the machine tool 48a at least for a greater part, in particular completely, as viewed in at least one plane, in a manner already known to a person skilled in the art. The suction element 66a is preferably mounted on the basic body 60a so as to be movable relative to the basic body 60a, in particular is mounted so as to be movable in a translatory manner on the basic body 60a. However, it is also conceivable for the suction element 66a to be arranged on the basic body 60a in a fixed position relative to the basic body 60a.

The suction device 10a comprises at least one damping unit 16a for a vibration-damped arrangement of the suction unit 14a on the portable power tool 12a. The damping unit 16a of the suction device 10a can be provided for interacting directly with the damping unit 36a of the portable power tool 12a, or the damping unit 16a of the suction device 10a can be provided, as an alternative to the damping unit 36a of the portable power tool 12a, to realize a vibration-damped arrangement of the suction unit 14a on the portable power tool 12a. The damping unit 16a of the suction device 10a comprises at least one damping element 18a which is in the form of an elastomer or a joint, wherein the damping element 18a of the damping unit 16a of the suction device 10a is at least partially arrangeable between the portable power tool 12a and the suction unit 14a. In particular, the damping element 18a of the damping unit 16a of the suction device 10a lies at least with one surface against the suction unit 14a, and the damping element 18a of the damping unit 16a of the suction device 10a lies with a further surface against the portable power tool 12a, in particular when the suction device 10a is arranged on the portable power tool 12a. The damping unit 16a of the suction device 10a has at least the damping element 18a which is designed to be adjustable with respect to at least one damping property. It is conceivable for the damping unit 16a of the suction device 10a to have at least one sensor element and at least one processor element (not illustrated specifically here) which is provided for at least partially automatically adjusting at least one damping property of the adjustable damping element 18a of the damping unit 16a of the suction device 10a with reference to detected sensor characteristic variables. For example, the at least one adjustable damping element 18a of the damping unit 16a of the suction device 10a is designed as a magneto-rheological damping element. However, it is also conceivable for the adjustable damping element 18a of the damping unit 16a of the suction device 10a to have another configuration appearing expedient to a person skilled in the art, such as, for example, as a hydraulic damping element or the like. It is also conceivable for the damping unit 16a of the suction device 10a to be designed independently of the at least one sensor element and the at least one processor element, and for at least one damping property of the adjustable damping element 18a of the damping unit 16a of the suction device 10a to be adjustable manually by an operator. However, it is also conceivable for the damping element 18a of the damping unit 16a of the suction device 10a to be designed to be adjustment-free with respect to at least one damping property.

The suction device 10a comprises at least one fastening unit 20a which has at least one fastening interface 22a for fastening the suction unit 14a to the portable power tool 12a, wherein at least the damping element 18a of the damping unit 16a is arranged at the fastening interface 22a. The fastening unit 20a can have any configuration appearing expedient to a person skilled in the art, such as, for example, a configuration as a quarter-turn fastener, as a latching groove, as a toggle lever fixing unit or the like. In particular, the fastening interface 22a is provided for coupling to a corresponding interface of the portable power tool 12a. The fastening unit 20a, in particular the fastening interface 22a, is preferably provided for a form-fitting and/or force-fitting connection to the portable power tool 12a, in particular to the interface of the portable power tool 12a.

The damping unit 16a of the suction device 10a and/or the damping unit 36a of the portable power tool 12a have/has at least one energy-harvesting element 30a which is provided for converting damping energy into electrical energy depending on a vibration damping of the damping unit 16a of the suction device 10a and/or of the damping unit 36a of the portable power tool 12a. Said energy can advantageously be used for charging up the energy supply unit 26a. It is also conceivable for the suction device 10a to have at least one energy supply interface (not illustrated specifically here) for an arrangement of at least one exchangeable energy supply unit (not illustrated specifically here), in particular at least one battery pack, wherein at least one damping element (not illustrated specifically here) of the damping unit 16a of the suction device 10a is arrangeable on the energy supply interface of the suction device 10a. Alternatively or additionally, the energy converted by means of the energy-harvesting element 30a could be used for charging up the energy supply unit which is arrangeable at the energy supply interface of the suction device 10a.

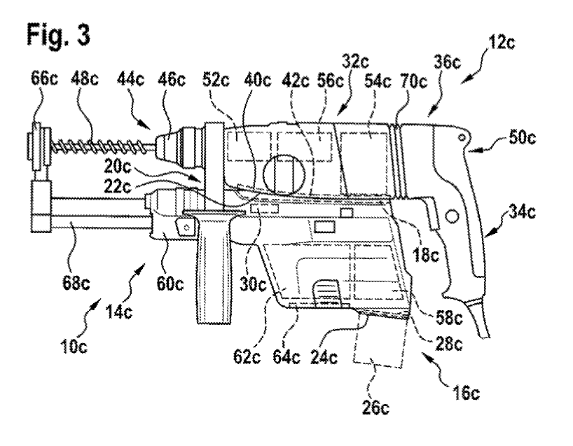

FIGS. 2 and 3 show two further exemplary embodiments of the disclosure. The descriptions below and the drawings are limited substantially to the differences between the exemplary embodiments, wherein, with regard to components with identical designations, in particular with regard to components with identical reference signs, reference can also be made in principle to the drawings and/or the description of the other exemplary embodiments, in particular FIG. 1. In order to distinguish between the exemplary embodiments, the letter a is positioned after the reference signs in the exemplary embodiment in FIG. 1. In the exemplary embodiments in FIGS. 2 and 3, the letter a is replaced by the letters b and c.

FIG. 2 shows a portable power tool 12b with at least one housing 32b, with at least one handle 34b and with at least one suction device 10b which is arrangeable removably on the housing 32b and/or on the handle 34b. The suction device 10b for the portable power tool 12b comprises at least one suction unit 14b for extracting and/or storing particles, in particular workpiece particles arising during machining of a workpiece with the portable power tool 12b. The portable power tool 12b and/or the suction device 10b comprise at least one damping unit 16b and/or 36b for a vibration-damped arrangement of the suction device 10b on the housing 32b and/or on the handle 34b. The suction device 10b comprises at least one fastening unit 20b which has at least one fastening interface 22b for fastening the suction unit 14b to the portable power tool 12b, wherein at least one damping element 18b of the damping unit 16b of the suction device 10b and/or of the damping unit 36b of the portable power tool 12b is arranged at the fastening interface 22b.

The suction device 10b comprises at least one energy supply interface 24b for an arrangement of at least one exchangeable energy supply unit 26b, in particular at least one battery pack, wherein at least one damping element 28b of the damping unit 16b of the suction device 10b is arranged on the energy supply interface 24b of the suction device 10b. The energy supply interface 24b of the suction device 10b is arranged on a side of a basic body 60b of a suction unit 14b of the suction device 10b, which side faces away from the portable power tool 12b, when the suction device 10b is arranged on the portable power tool 12b. The damping unit 16b of the suction device 10b comprises at least one energy-harvesting element 30b which is provided for converting damping energy into electrical energy depending on a vibration damping of the damping unit 16b of the suction device 10b.

The portable power tool 12b comprises at least one energy supply interface 38b for an arrangement at least of the exchangeable energy supply unit 26b, in particular of at least one battery pack, on which the damping unit 36b of the portable power tool 12b is at least partially arranged, wherein the suction device 10b is arrangeable releasably at the energy supply interface 38b of the portable power tool 12b. The suction device 10b comprises at least one fastening unit 20b for an arrangement on the energy supply interface 38b of the portable power tool 12b. The fastening unit 20b of the suction device 10b is designed in particular in a manner corresponding to an energy supply interface 38b of the portable power tool 12b.

The damping unit 36b of the portable power tool 12b is at least partially arranged between the housing 32b and the handle 34b, wherein the suction device 10b is arrangeable, at least for the greater part, on the handle 34b. The energy supply interface 38b of the portable power tool 12b is arranged on the handle 34b. With regard to further features of the suction device 10b and/or of the portable power tool 12b, reference may be made to the suction device 10a and/or portable power tool 12a described in the description of FIG. 1.

FIG. 3 shows a portable power tool 12c with at least one housing 32c, with at least one handle 34c and with at least one suction device 10c which is arrangeable removably on the housing 32c and/or on the handle 34c. The suction device 10c for the portable power tool 12c comprises at least one suction unit 14c for extracting and/or storing particles, in particular workpiece particles arising during machining of a workpiece with the portable power tool 12c. The portable power tool 12c and/or the suction device 10c comprise at least one damping unit 16c and/or 36c for a vibration-damped arrangement of the suction device 10c on the housing 32c and/or on the handle 34c. The suction device 10c comprises at least one fastening unit 20c which has at least one fastening interface 22c for fastening the suction unit 14c to the portable power tool 12c, wherein at least one damping element 18c of the damping unit 16c of the suction device 10c and/or of the damping unit 36c of the portable power tool 12c is arranged at the fastening interface 22c. In contrast to the portable power tool 12a described in the description of FIG. 1, the portable power tool 12c which is illustrated in FIG. 3 is designed as a portable power tool which is operable in a wired manner. An energy supply of the suction device 10c can take place by means of electrical contact connection as the result of an arrangement of the suction device 10c on the portable power tool 12c, or the suction device 10c can itself have an energy supply. The suction device 10c can comprise at least one energy supply interface 24c (merely indicated in FIG. 3) for an arrangement of at least one exchangeable energy supply unit 26c (merely indicated by dashed lines in FIG. 3), in particular of at least one battery pack, wherein at least one damping element (not illustrated specifically here) of the damping unit 16c of the suction device 10c can be arranged at the energy supply interface 24c of the suction device 10c. It is likewise conceivable for the suction device 10c to be designed to be operable independently of an electrical energy supply and for a fluid flow for extraction of particles to be able to be produced by means of a drive unit Mc of the portable power tool 12c, in particular when the suction device 10c is arranged on the portable power tool 12c. With regard to further features of the suction device 10c and/or of the portable power tool 12c, reference may be made to the suction device 10a and/or portable power tool 12a described in the description of FIG. 1.

What is claimed is:

1. A suction device for a portable power tool, comprising:
at least one suction unit configured to one or more of extract and store particles arising during machining of a workpiece with the portable power tool; and
at least one damping unit configured for a vibration-damped arrangement of the suction unit on the portable power tool.

2. The suction device according to claim 1, wherein the damping unit has at least one damping element configured as an elastomer or a joint, the damping element at least partially arranged between the portable power tool and the suction unit.

3. The suction device according to claim 1, further comprising at least one fastening unit that has at least one fastening interface configured to fasten the suction unit to the portable power tool, the damping unit having at least one damping element arranged at the fastening interface.

4. The suction device according to claim 1, wherein the damping unit has at least one damping element configured to be adjustable with respect to at least one damping property.

5. The suction device according to claim 1, further comprising at least one energy supply interface configured for an arrangement of at least one exchangeable energy supply unit, the damping unit having at least one damping element arranged at the energy supply interface.

6. The suction device according to claim 1, wherein the damping unit has at least one energy-harvesting element configured to convert damping energy into electrical energy depending on a vibration damping of the damping unit.

7. A portable power tool, comprising:
at least one housing;
at least one handle; and
at least one suction device that is removably arranged on one or more of the housing and the handle, the suction device including:
at least one suction unit configured to one or more of extract and store particles arising during machining of a workpiece with the portable power tool, and
at least one damping unit configured for a vibration-damped arrangement of the suction unit on the one or more of the housing and the handle.

8. The portable power tool according to claim 7, wherein the damping unit is at least partially arranged between the housing and the handle, and wherein the suction device is configured to be arranged more on the handle than on the housing.

9. The portable power tool according to claim 7, further comprising at least one energy supply interface configured for an arrangement of at least one exchangeable energy supply unit on which the damping unit is at least partially arranged, wherein the suction device is releasably arranged at the energy supply interface.

10. The portable power tool at least according to claim 7, wherein the housing has at least one receiving interface configured to receive the suction device, and wherein the damping unit has at least one damping element arranged at the receiving interface.

11. The suction device according to claim 5, wherein the at least one exchangeable energy supply unit is configured as at least one battery pack.

12. The portable power tool according to claim 9, wherein the at least one exchangeable energy supply unit is configured as at least one battery pack.
